(19) United States
(12) Patent Application Publication
(10) Pub. No.: US 2022/0270473 A1
(43) Pub. Date: Aug. 25, 2022

(54) REMOTE CONTROL COMPANION SYSTEM

(71) Applicant: ARRIS Enterprises LLC, Suwanee, GA (US)

(72) Inventor: Charles Peter CHEEVERS, Alpharetta, GA (US)

(21) Appl. No.: 17/672,933

(22) Filed: Feb. 16, 2022

Related U.S. Application Data
(60) Provisional application No. 63/151,137, filed on Feb. 19, 2021.

(51) Int. Cl. G08C 17/02

(52) U.S. Cl. CPC G08C 17/02; G08C 2201/20

(57) ABSTRACT

A client device for use with a network device, a customer premises device, a remote control device, and an external network, the network device being configured to communicate with the external network and transmit a reconfiguration instruction to the remote control device. The client device includes a memory and a processor configured to execute instructions stored on the memory to cause the client device to receive a user input signal associated with a reconfiguration of the customer premises device. The client device may also transmit a reconfiguration instruction to the network device via the external network so as to cause the network device to transmit the reconfiguration instruction to the remote control device. The remote control device may then transmit the control signal to the customer premises device based on the reconfiguration instruction to cause the customer premises device to reconfigure based on the control signal.

### BACKGROUND

Embodiments of the present disclosure relate to reconfiguring a television and finding a remote control.

### SUMMARY

Aspects of the present disclosure are drawn to a client device for use by a user and with a network device, a customer premises device, a remote control device, and an external network, the network device being configured to communicate with the external network and transmit a reconfiguration instruction to the remote control device. The remote control device is configured to transmit a control signal to the customer premises device based on the reconfiguration instruction. The customer premises device is configured to reconfigure based on the control signal. The client device includes a memory and a processor configured to execute instructions stored on the memory to cause the client device to receive a user input signal associated with a reconfiguration of the customer premises device; transmit a reconfiguration instruction to the network device via the external network so as to cause the network device to transmit the reconfiguration instruction to the remote control device to cause the remote control device to transmit the control signal to the customer premises device based on the reconfiguration instruction, and to cause the customer premises device to reconfigure based on the control signal.

In some embodiments, the client device further includes a user interface configured to generate the user input signal based on a user input.

In some embodiments, the user interface includes a microphone configured to generate the user input signal based on a received vocal command by the user.

In some embodiments, the user interface includes a button configured to generate the user input signal based on a pressing of the button by the user.

Other aspects of the present disclosure are drawn to a method of using a client device for use by a user and with a network device, a customer premises device, a remote control device, and an external network. The network device is configured to communicate with the external network and transmit a reconfiguration instruction to the remote control device. The remote control device is configured to transmit a control signal to the customer premises device based on the reconfiguration instruction. The customer premises device is configured to reconfigure based on the control signal. The method includes receiving, via a processor configured to execute instructions stored on a memory, a user input signal associated with a reconfiguration of the customer premises device; and transmitting, via the processor, a reconfiguration instruction to the network device via the external network so as to cause the network device to transmit the reconfiguration instruction to the remote control device, to cause the remote control device to transmit the control signal to the customer premises device based on the reconfiguration instruction, and to cause the customer premises device to reconfigure based on the control signal.

In some embodiments, the method further includes generating, via a user interface, the user input signal based on a user input.

In some embodiments, generating the user input signal includes generating, via a button, the user input signal based on a received vocal command by the user.

In some embodiments, generating the user input signal includes generating, via a microphone, the user input signal based on a pressing of the button by the user.

Aspects of the present disclosure are further drawn to a non-transitory, computer-readable media having computer-readable instructions stored thereon, the computer-readable instructions being capable of being read by a client device for use by a user and with a network device, a customer premises device, a remote control device, and an external network. The network device is configured to communicate with the external network and transmit a reconfiguration instruction to the remote control device. The remote control device is configured to transmit a control signal to the customer premises device based on the reconfiguration instruction. The customer premises device is configured to reconfigure based on the control signal, wherein the computer-readable instructions are capable of instructing the client device to perform the method including: receiving, via a processor configured to execute instructions stored on a memory, a user input signal associated with a reconfiguration of the customer premises device; and transmitting, via the processor, a reconfiguration instruction to the network device via the external network so as to cause the network device to transmit the reconfiguration instruction to the remote control device, to cause the remote control device to transmit the control signal to the customer premises device based on the reconfiguration instruction, and to cause the customer premises device to reconfigure based on the control signal.

In some embodiments, the computer-readable instructions are capable of instructing the client device to perform the method further including generating, via a user interface, the user input signal based on the user input.

In some embodiments, the computer-readable instructions are capable of instructing the client device to perform the method where generating the user input signal comprises generating, via a button, the user input signal based on a received vocal command by the user.

In some embodiments, the computer-readable instructions are capable of instructing the client device to perform the method where generating the user input signal comprises generating, via a microphone, the user input signal based on a pressing of the button by the user.

Other aspects of the present disclosure are drawn to a client device for use by a user and with a network device, a customer premises device, a remote control device, and an external network. The network device is configured to communicate with the external network and transmit an instruction to the remote control device. The remote control device is configured to perform a function based on the instruction. The client device includes a memory and a processor configured to execute instructions stored on the memory to cause the client device to: receive a user input signal associated with the function of the remote control device; transmit the instruction to the network device via the external network so as to cause the network device to transmit the instruction to the remote control device, to cause the remote control device to perform the function.

In some embodiments, the instruction causes the remote control device to emit a sound.

In some embodiments, the instruction causes the remote control device to transmit a control signal to the customer premises device to cause the customer premises device to reconfigure based on the control signal.

Other aspects of the present disclosure are drawn to a method of using a client device for use by a user and with a network device, a customer premises device, a remote control device, and an external network. The network device is configured to communicate with the external network and transmit an instruction to the remote control device. The remote control device is configured to perform a function based on the instruction. The method includes: receiving, via a processor configured to execute instructions stored on a memory, a user input signal associated with the function of the remote control device; and transmitting, via the processor, the instruction to the network device via the external network so as to cause the network device to transmit the instruction to the remote control device, to cause the remote control device to perform the function.

In some embodiments, the instruction causes the remote control device to emit a sound.

In some embodiments, the instruction causes the remote control device to transmit a control signal to the customer premises device to cause the customer premises device to reconfigure based on the control signal.

Other aspects of the present disclosure are drawn to a non-transitory, computer-readable media having computer-readable instructions stored thereon. The computer-readable instructions are capable of being read by a client device for use by a user and with a network device, a customer premises device, a remote control device, and an external network. The network device is configured to communicate with the external network and transmit an instruction to the remote control device. The remote control device is configured to perform a function based on the instruction, wherein the computer-readable instructions are capable of instructing the client device to perform the method including: receiving, via a processor configured to execute instructions stored on a memory, a user input signal associated with the function of the remote control device; and transmitting, via the processor, the instruction to the network device via the external network so as to cause the network device to transmit the instruction to the remote control device, to cause the remote control device to perform the function.

In some embodiments, the computer-readable media instructions are capable of instructing the client device to perform the method wherein the instruction causes the remote control device to emit a sound.

In some embodiments, the computer-readable instructions are capable of instructing the client device to perform the method wherein the instruction causes the remote control device to transmit a control signal to the customer premises device to cause the customer premises device to reconfigure based on the control signal.

### BRIEF SUMMARY OF THE DRAWINGS

The accompanying drawings, which are incorporated in and form a part of the specification, illustrate example embodiments and, together with the description, serve to explain the principles of the present disclosure. In the drawings:

FIG. 1 illustrates a conventional communication system at a time t₀;

FIG. 2 illustrates an algorithm to be executed by a processor for reconfiguring a device in the client residence in accordance with aspects of the present disclosure;

FIG. 3A illustrates a communication system at a time t₁ in accordance with aspects of the present disclosure;

FIG. 3B illustrates the communication system of FIG. 3A at a time t₂;

FIG. 4 illustrates an exploded view of an external server, a client device, a gateway device, and a remote.

FIG. 5A illustrates a non-limiting example of a display displaying a graphic user interface (GUI) at a time t₃ in accordance with aspects of the present disclosure;

FIG. 5B illustrates a non-limiting example of a display displaying a GUI at a time t₄;

FIG. 6 illustrates a non-limiting example look up table (LUT) at a time t₅, in accordance with aspects of the present disclosure;

FIG. 7 illustrates an algorithm to be executed by a processor for finding a remote control in accordance with aspects of the present disclosure; and

FIG. 8 illustrates a non-limiting example of a display displaying a GUI at a time t₆, in accordance with aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

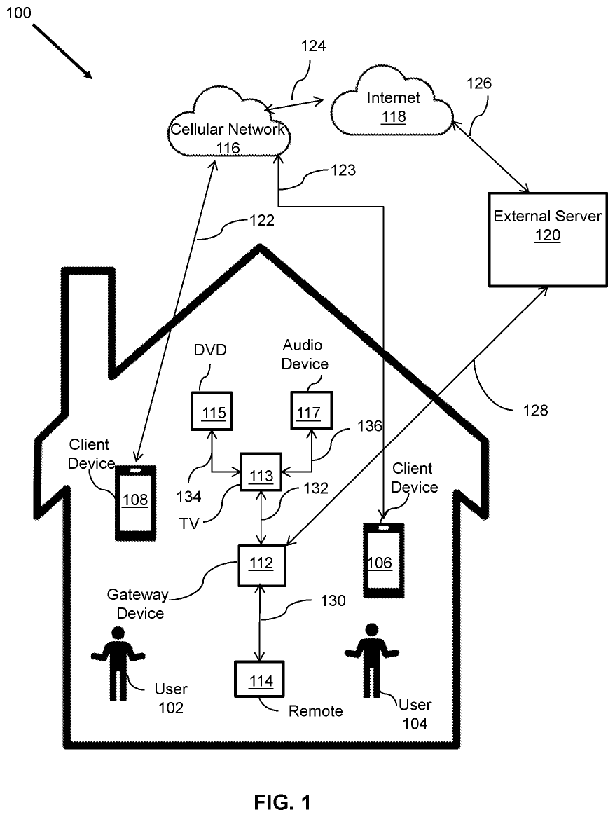

FIG. 1 illustrates a conventional communication system 100 at a time t₀.

As shown in the figure, communication system 100 includes a user 102, a user 104, a client device 106, a client device 108, a gateway device 112, a TV 113, a remote 114, a DVD player 115, a cellular network 116, an audio device 117, Internet 118, an external server 120, a communication channel 122, a communication channel 123, a communication channel 124, a communication channel 126, a communication channel 128, a communication channel 130, a communication channel 132, a communication channel 134, and a communication channel 136.

As shown in the figure, client device 106 is configured to communicate with cellular network 116 via communication channel 123 and to wirelessly communicate with gateway device 112 so as to access external server 120. Client device 108 is configured to communicate with cellular network 116 via communication channel 122 and to wirelessly communicate with gateway device 112 so as to access external server 120Cellular network 116 is able to communicate with Internet 118 via communication channel 124. Internet 118 is able to communicate with external server 120 via communication channel 126. External server 120 is able to communicate with gateway device 112 via communication channel 128. Remote 114 is able to communicate with gateway device 112 via communication channel 130. Gateway device 112 is able to communicate with TV 113 via communication channel 132. TV 113 is able to communicate with DVD 115 via communication channel 134. TV 113 is also able to communicate with audio device 117 via communication channel 136.

Gateway device 112, also referred to as a gateway, residential gateway, or RG, is an electronic device that is to be located as to establish a local area network (LAN) at a consumer premises. The consumer premises can include a residential dwelling, office, or any other business space of a user. The terms home, office, and premises may be used synonymously herein. Further, in this disclosure, gateway device 112 additionally performs the functions of a cable modem, wherein video content may be delivered to the residence from an external server.

Gateway device 112 may be any device or system that is operable to allow data to flow from one discrete network to another, which in this example is from the LAN to Internet 118 by way of communication channel 128 and external server 120. Gateway device 112 may perform such functions as web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Gateway device 112 establishes, or is part of a WLAN, using Wi-Fi for example, such that client devices 106 and 108 are able to communicate wirelessly with gateway device 112. The term Wi-Fi as used herein may be considered to refer to any of Wi-Fi 4, 5, 6, 6E, or any variation thereof.

Further, it should be noted that gateway device 112 is able to communicate with external network 120 via physical media/wiring 128, which may optionally be a wireless communication system, such as 4G, or 5G, and is further able to connect to Internet 118 via external network 120.

Gateway device 112 serves as a gateway or access point to external network 120, e.g., Internet 118 (or otherwise as mentioned above), for one or more electronic devices, referred to generally herein as client devices 106 and 108 that wirelessly communicate with gateway device 112 via, e.g., Wi-Fi. Client device 106 and 108 can be desk top computers, laptop computers, electronic tablet devices, smart phones, appliances, or any other so called internet of things equipped devices that are equipped to communicate information via a WLAN.

Many people in the aging population may not be sophisticated with reference to their remote controls or televisions within their home. If for some reason an aging person chooses to switch the inputs on their television or if a family member were to come to the residence of the aging person and change the input on the television, the aging person may not be able to change the input back. These types of situations may cause a lot of stress and anxiety for the aging person that lacks sophistication with electronic devices. Further, a caregiver or relative may actually have to go to the home of the aging person to help the aging person change the input back to its previous state. This can be both inconvenient and stressful for the caregiver or relative as well. For example, with reference to FIG. 1, imagine that user 102 is a family member of user 104 and user 102 changes the input from audio device 117 to DVD 115 and then leave the residence. User 104 may not know how to change the input back using remote 114 and may require user 102 to return to the residence after leaving.

Another issue with the aging population may also be misplacing a remote. With reference to FIG. 1, imagine that user 104 is an aging person who has misplaced remote 114 somewhere within the residence, and as a result they are unable to turn on TV 113. User 104 may even contact user 102 who may have left the residence to try to help user 104 find remote 114. Again, this can cause a lot of stress and anxiety for the aging person as well as pose an inconvenience to user 102 if they constantly need to help user 104 find remote 114.

What is needed is a system and method to make it easy to reconfigure a television and find a remote control.

A system and method in accordance with the present disclosure provides a user-friendly means of reconfiguring a television and finding a remote control.

In accordance with the present disclosure, a system and a method are provided that make it easy for either an aging user or a family member or caregiver of the aging user to reconfigure a television and/or find a remote control. In order to overcome the issue regarding difficulty selecting inputs, a system in accordance with aspects of the present disclosure allows the user to do so from the client device rather than through the remote control. A system in accordance with aspects of the present disclosure additionally uses an input controller that allows the user to select input presets from their client device. This way, instead of having to remember which input (e.g,. TV, DVD, HDMI 1, HDMI 2, etc.) corresponds with which device (e.g., the set-top box, the DVD player, a streaming device, etc.), the user can assign friendly names such as “watch DVD” or “watch cable” to make the process of changing inputs easier for an aging person. Further, the input controller may be accessed and controlled via a cellular network and through the internet.

For example, in one embodiment, an HDMI source may be changed via a cloud-based server using a smart phone as well as local voice control. In the event that a media device connected to an HDMI1 source slot on a television is changed, e.g., the aging person has pressed source button on the television remote control, then the family member or caregiver of the aging user may cycle the HDMI ports using their smart phone.

In another embodiment, the television remote control may have a two-way communication capability, wherein again the family member or caregiver of the aging user may cycle the HDMI ports using their smart phone. However, in this embodiment, a local infrared (IR) blaster of the television remote control may be instructed to blast an IR instruction signal to the television to change the HDMI source to the HDMI1 source slot.

In this way, a loved one or caregiver may assist the aging person by changing the input from inside or outside the residence.

A system and method in accordance with aspects of the present disclosure also enables a person to easily find a remote using a client device. After hitting the “find remote” command on the client device, the remote may light up, make a sound, vibrate, or any combination thereof, to aid in locating the remote. This additionally benefits the caregivers or family members of the aging person because they will not have to go to the residence to assist in finding the remote control.

Advantage of the present disclosure includes enabling an aging person to easily change the input of their device. Not only will this decrease the aging person's stress and anxiety regarding the use of technology, it will also allow the aging person to keep some aspect of their independence. Additionally, it allows family members or caregivers to help the aging person without having to step into the home. This may relieve some of the stress off of the family members or caregivers while also removing some of the inconvenience associated with going to the residence to help the family member with their devices. Another advantage of the present disclosure is the ability to easily find a remote that was lost within the residence through the use of a client device. Similar to the situations mentioned previously, this can be done by the aging person within the residence or by a caregiver or family member outside of the residence. This, again, allows the aging person to retain some independence while being able to easily use their devices, as well as allowing caregivers or family members to help them as needed.

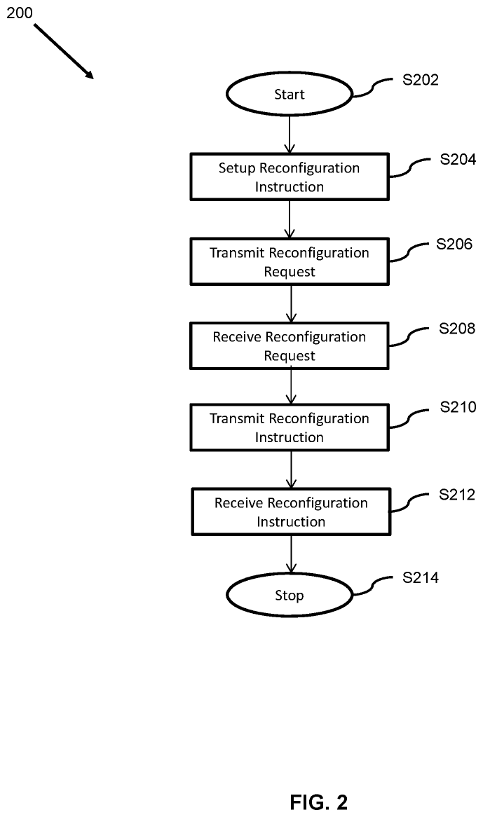

An example system and method for reconfiguring a television in accordance with aspects of the present disclosure will now be described in greater detail with reference to FIGS. 2-6.

FIG. 2 illustrates an algorithm 200 to be executed by a processor for reconfiguring a device in the client residence in accordance with aspects of the present disclosure.

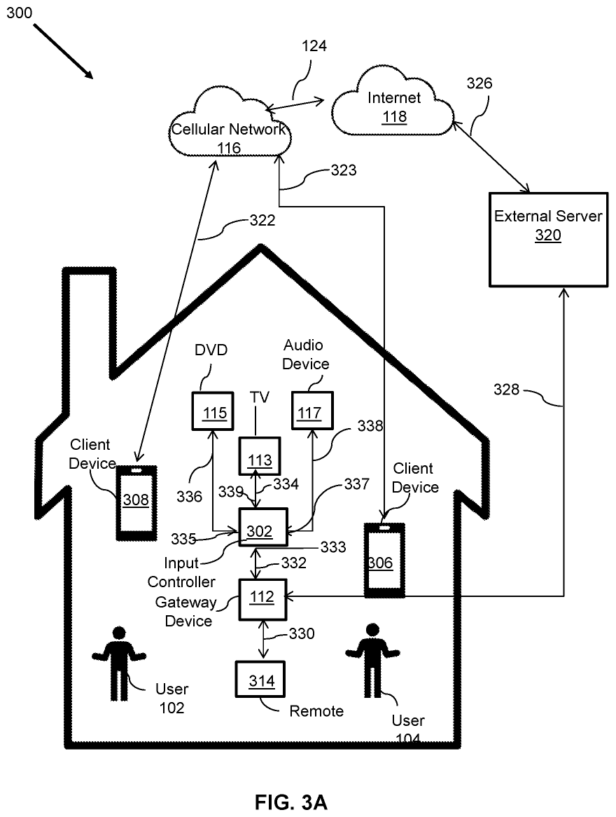

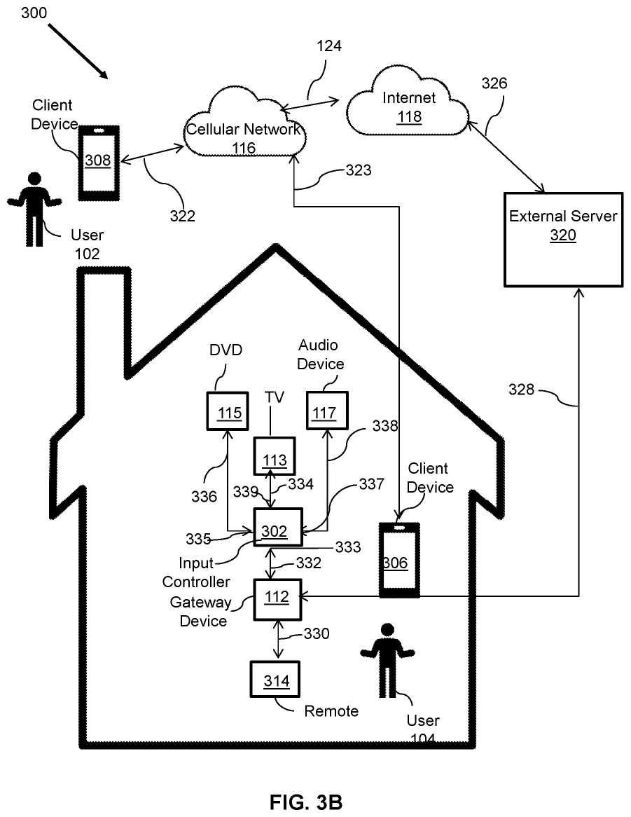

As shown in the figure, algorithm 200 starts (S202), and a setup reconfiguration instruction is given (S204). An example embodiment will be shown with reference to FIGS. 3A-B, 4, and 6.

FIG. 3A illustrates a communication system 300 at a time t₁ in accordance with aspects of the present disclosure.

As shown in the figure, communication system 300 includes user 102, user 104, gateway device 112, TV 113, DVD 115, cellular network 116, audio device 117, Internet 118, an input controller 302, a client device 306, a client device 308, a remote 314, an external server 320, an input 333, an input 335, an input 337, an output 339, a communication channel 322, communication channel 124, a communication channel 326, a communication channel 328, a communication channel 329, a communication channel 330, a communication channel 332, a communication channel 334, a communication channel 336, and a communication channel 338.

As shown in the figure, client device 308 is configured to communicate with cellular network 116 via communication channel 322. Cellular network 116 is able to communicate with internet 118 via communication channel 324. Internet 118 is configured to communicate with external server 320 via communication channel 326. External server 320 is able to communicate with gateway device 112 via communication channel 328. Remote 314 is configured to communicate with gateway device 112 via communication channel 330. Gateway device 112 is able to communicate with input controller 302 via communication channel 332. Input controller 302 is able to communicate with TV 113 via communication channel 334. Input controller 302 is also able to communicate with DVD 115 via communication channel 336. Input controller 302 additionally is able to communicate with audio device 117 via communication channel 338.

In accordance with aspects of the present disclosure a user may use their phone to control aspects of the input controller or instruct a remote to provide an indication so that the remote may be located. For example, in FIGS. 3A-B, user 104 may use client device 306, which may for example be a smart phone, whereas user 102 may use client device 308, which may additionally be a smart phone. In this manner, for purposes of discussion, each of client device 306 and client device 308 may operate in a similar manner.

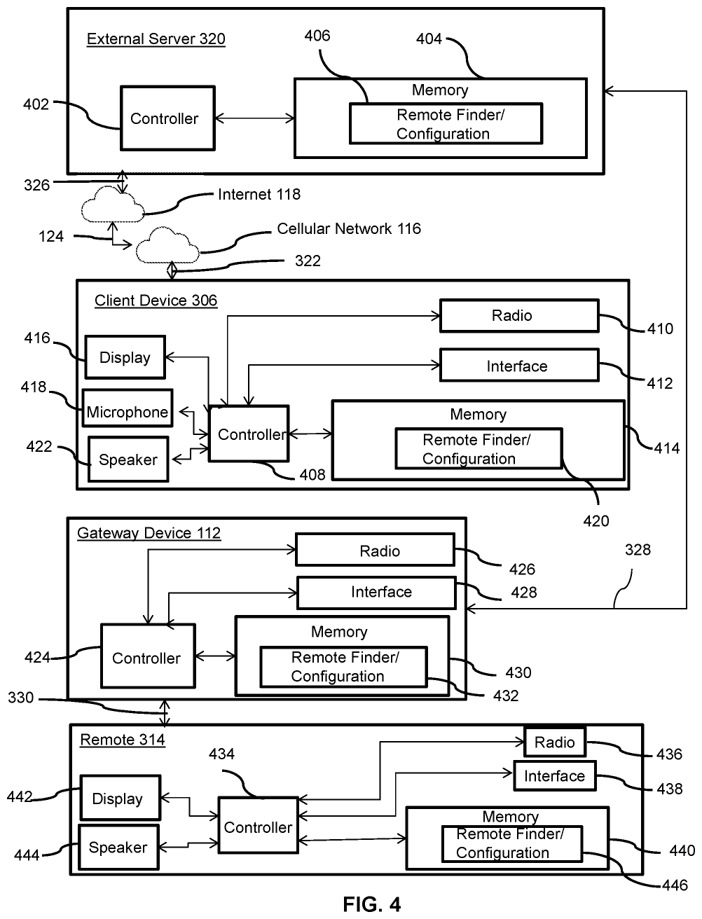

FIG. 4 illustrates an exploded view of external server 320, client device 306, gateway device 112, and remote 314 as shown in FIGS. 3A-B.

As shown in FIG. 4, gateway device 112 includes: a controller 424; a memory 430, which has stored therein, a remote finder and configuration program 432; at least one radio, a sample of which is illustrated as a radio 426; and an interface circuit 428.

In this example, controller 424, memory 430, radio 426, and interface circuit 428 are illustrated as individual devices. However, in some embodiments, at least two of controller 424, memory 430, radio 426, and interface circuit 428 may be combined as a unitary device. Whether as individual devices or as combined devices, controller 424, memory 430, radio 426, and interface circuit 428 may be implemented as any combination of an apparatus, a system and an integrated circuit. Further, in some embodiments, at least one of controller 424, memory 430 and interface circuit 428 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 424 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of gateway device 112 in accordance with the embodiments described in the present disclosure. Memory 430 can store various programming, and user content, and data. Interface circuit 428 can include one or more connectors, such as RF connectors, or Ethernet connectors, and/or wireless communication circuitry, such as 5G circuitry and one or more antennas. Interface circuit 428 receives content from external server 320 (as shown in FIG. 3A) by known methods, non-limiting examples of which include terrestrial antenna, satellite dish, wired cable, DSL, optical fibers, or 5G as discussed above. Through interface circuit 428, gateway device 112 receives an input signal, including data and/or audio/video content, from external server 320 and can send data to external server 320.

Radio 426, (and preferably two or more radios), may also be referred to as a wireless communication circuit, such as a Wi-Fi WLAN interface radio transceiver and is operable to communicate with client devices 306 and 308 and with remote 314. Radio 426 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Gateway device 112 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol.

External server 320 includes: a controller 402, and a memory 404, which has stored therein, a remote finder and configuration program 406.

Controller 402 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of external server 320 in accordance with the embodiments described in the present disclosure.

Memory 404 can store various programming, and user content, and data including remote finder program 406. Remote finder program 406 includes instructions, that when executed by controller 402 enables client device 306 to initiate onboarding onto gateway device 112.

Remote 314 includes: a controller 434; a memory 440, which has stored therein, a remote finder and configuration program 446; at least one radio, a sample of which is illustrated as radio 436; an interface circuit 438; a display 442; and a speaker 444.

In this example, controller 434, memory 440, radio 436, interface circuit 438, display 442, and speaker 444 are illustrated as individual devices. However, in some embodiments, at least two of controller 434, memory 440, radio 436, interface circuit 438, display 442, and speaker 444 may be combined as a unitary device. Further, in some embodiments, at least one of controller 434 and memory 440 may be implemented as a computer having tangible computer-readable media for carrying or having computer-executable instructions or data structures stored thereon.

Controller 434, may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of remote 314 in accordance with aspects of the present disclosure.

Memory 440 can store various programming, and user content, and data including remote finder program 446. As will be described in greater detail below, remote finder program 446 includes instructions, that when executed by controller 434 enables remote 314 to provide an indication. The indication may take the form of a light (constant, or changing), a sound, a vibration or combination thereof to aid in discover of the device by user 104.

Interface circuit 438 can include one or more connectors, such as RF connectors, or Ethernet connectors, and/or wireless communication circuitry, such as 5G circuitry and one or more antennas. Interface circuit 438 enables a user (not shown) to interface with controller 434 to manually operate or configure remote 314. Interface circuit 438 further enables controller 434 to decode communication signals received by radio 436 from gateway device 112 and to encode communication signals to be transmitted by radio 436 to gateway device 112.

Radio 436, may include a Wi-Fi WLAN interface radio transceiver that is operable to communicate with gateway device 112, as shown in FIG. 3A and also may include a cellular transceiver operable to communicate with a cellular service provider (not shown) through a cellular network. Radio 436 includes one or more antennas and communicates wirelessly via one or more of the 2.4 GHz band, the 5 GHz band, 6 GHz band, and the 60 GHz band, or at the appropriate band and bandwidth to implement the Wi-Fi 4, 5, 6, or 6E protocols. Remote 314 can also be equipped with a radio to implement a Bluetooth interface radio transceiver and antenna, which communicates wirelessly in the ISM band, from 2.400 to 2.485 GHz. As an alternative, at least one of the radios can be a radio meeting a Radio Frequency for Consumer Electronics (RF4CE) protocol, ZigBee protocol, and/or IEEE802.15.4 protocol, which also communicates in the ISM band.

Client device 306 includes: a controller 408; a main memory 414, which has stored therein, a remote finder and configuration program 420; at least one radio, a sample of which is illustrated as a radio 410; an interface 412; a display 416; a microphone 418; and a speaker 422.

In this example, controller 408, main memory 414, radio 410, interface 412, display 416, microphone 418, and speaker 422 are illustrated as individual devices. However, in some embodiments, at least two of controller 408, main memory 414, radio 410, interface 412, display 416, microphone 418, and speaker 422 may be combined as a unitary device. Further, in some embodiments, at least one of controller 408 and main memory 414 may be implemented as a computer having tangible computer-readable media for carrying or having computer-executable instructions or data structures stored thereon.

As will be described in greater detail below, controller 408 is configured to execute instructions stored in memory 414 to cause client device 306 to receive a user input signal associated with a reconfiguration of input controller 302, and transmit a reconfiguration instruction input controller 302 via cellular network 116 so as to cause gateway device 112 to transmit the reconfiguration instruction to remote 314, wherein remote 314 will then transmit a control signal to input controller 302 based on the reconfiguration instruction and input controller 302 to reconfigure based on the control signal.

As will be described in greater detail below, in some embodiments, controller 408 is configured to execute instructions stored in memory 414 to cause client device 306 to receive a user input signal associated with the function of remote 314, and to transmit an instruction via external server 320 so as to cause gateway device 112 to transmit the instruction to remote 314 to cause remote 314 to perform the function. In some of these embodiments, the instruction may cause remote 314 to emit a sound.

Controller 408 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of client device 306 in accordance with the embodiments described in the present disclosure.

Memory 414 can store various programming, and user content, and data.

Radio 410, may include a Wi-Fi wireless LAN (WLAN) interface radio transceiver that is operable to communicate with client device 306 and with gateway device 112, as shown in FIG. 3A and also may include a cellular transceiver operable to communicate with Internet 118 through cellular network 116. Radio 410 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Client device 306 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Any device within the LAN illustrated in FIGS. 3A-B may be a mobile device similar to client device 306. In this respect, it should be noted that client device 308 includes similar components and operates in a similar manner to client device 306. For purposes of brevity, a more detailed discussion of client device 308 will therefore not be included here. In the event that a client device within the LAN illustrated in FIGS. 3A-B is not a mobile device similar to client device 306, such a client device may still include: a controller, which can include a dedicated hardware circuitry such as a dedicated control circuit, CPU, microprocessor, etc., and that controls the circuits of the client device; a main memory, which has stored therein an remote finder program, that is similar to main memory 414 and remote finder program 420, respectively, of client device 306 discussed above; a radio similar to radio 410 of client device 306 discussed above; in additional to further functional circuitry. Accordingly, any of the client devices may include a Wi-Fi WLAN interface radio transceiver, that is operable to communicate with other client devices and with gateway device 112, as shown in FIG. 3A and also may include a cellular transceiver operable to communicate with Internet 118 through cellular network 116. Further, any of the client devices may include a radio that is similar to radio 410 of client device 306 discussed above. Still further, any of the client devices may be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol, in a manner similar to client device 306 discussed above.

Insofar as gateway device 112 provides connection to external server 320, such as an MSO, gateway device 112 can be equipped with connectors to connect with a television or display device, and can also include programming to execute an electronic program guide and/or other suitable graphical user interface (GUI), and can with such configuration be referred to as a so called set top box. Such a set top box can be included in the system shown in FIGS. 3A-B as gateway device 112 or in addition thereto. Moreover, inclusion of one or more of far-field microphones, (for e.g., voice command and/or presence recognition, and/or telephone communication), cameras, (for e.g., gesture and/or presence recognition, and/or video telephone communication), and speakers, and associated programming, can enable the gateway device to be a so called smart media device.

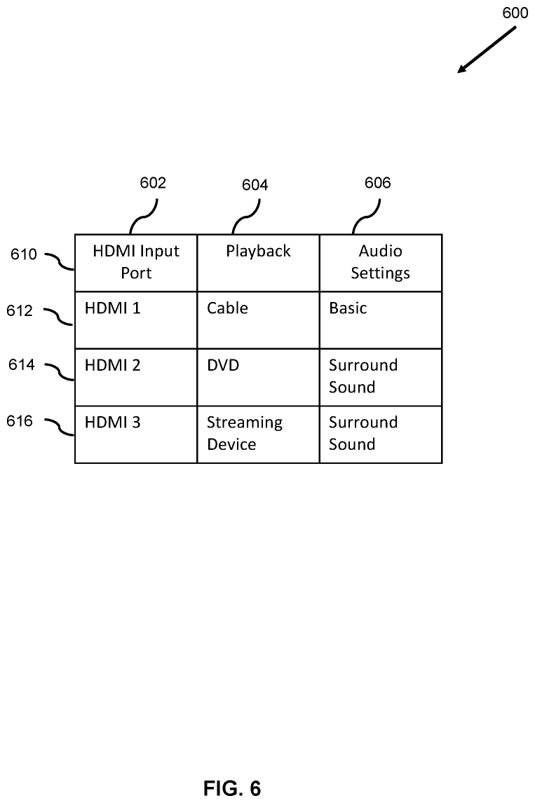

FIG. 6 illustrates a non-limiting example of a LUT 600 at a time t₅, in accordance with aspects of the present disclosure.

As shown in the figure, LUT 600 includes a HDMI input port column 602, a playback column 604, an audio settings column 606, a row 610, a row 612, a row 614, and a row 616. In this example, as shown in row 612, the HDMI 1 input port is assigned to a cable TV (via a gateway device) having basic audio setting. As shown in row 614, the HDMI 2 input port is assigned to a DVD player having surround sound. As shown in row 616, the HDMI 3 input port is assigned to a streaming device having surround sound.

In an example embodiment, LUT 600 is stored in memory 440, as shown in FIG. 4, of remote 314.

For the purpose of discussion, consider the following situation with reference to FIG. 3A. User 102 is a family member of user 104, who is an aging person living in the home. In order to assist user 104 and allow them to be more independent, user 102 has set up reconfiguration instructions for user 104 to give them easy access to the things they most commonly watch. For example, with reference to FIG. 6, LUT 600 shows a non-limiting example of HDMI presets. If, for example, with reference to FIG. 3A, user 102 were to change the input of TV 113 and then leave the premises, user 104 would be able to change the input using client device 308 rather than having to do so manually.

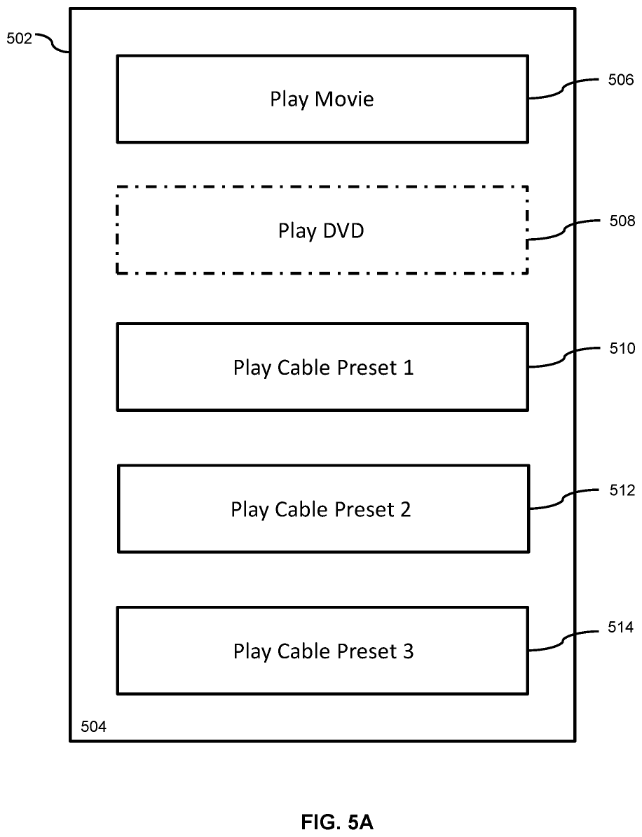

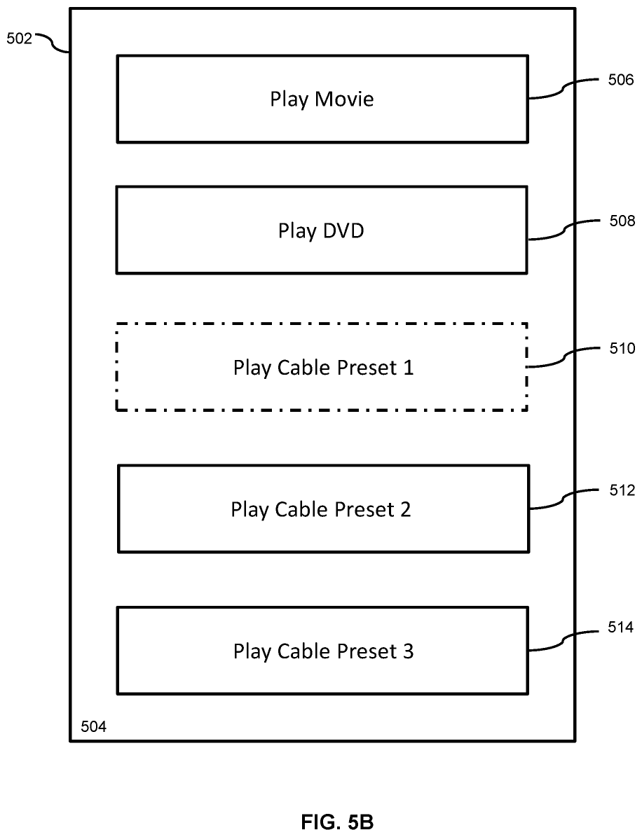

Returning to FIG. 2, after a setup reconfiguration instruction is given (S204), a reconfiguration request is transmitted (S206). This will be described in greater detail with reference to FIGS. 3A and 5A-B.

FIG. 5A illustrates a non-limiting example of display 416, of client device 306, displaying a GUI 504 at a time t₃ in accordance with aspects of the present disclosure. It should be noted that client device 308 may have a similar display and corresponding GUI. However, for purposes of brevity, the display and GUI of client device 308 will not be discussed here.

As shown in the figure, display 416 includes non-limiting examples of user selectable menu items 506, 508, 510, 512, and 514.

In this example, user selectable menu item 508, play DVD, was chosen as indicated by the dotted border.

FIG. 5B illustrates a non-limiting example of a display 416 displaying GUI 504 at a time t₄ in accordance with aspects of the present disclosure.

FIG. 5B is similar to FIG. 5A with the exception that instead of user selectable menu item 508 being chosen, user selectable menu item 510 is alternatively chosen.

Returning to FIG. 3A, for the purpose of discussion, consider the following situation. User 102 is a family member of user 104 and user 102 has changed modified input controller 302 such that the input to TV 113 as provided by gateway device 112, wherein cable television was being viewed, is replaced with input as provided by DVD 115, wherein a DVD movie would be viewed, while visiting the residence of user 104. Later, after user 102 leaves the residence of user 104, user 104 wishes to change the input to TV 113 back to gateway device 112.

In accordance with aspects of the present disclosure, user 104 is able to use client device 306 to change the input and FIGS. 5A and 5B show an example of this change. With reference to FIG. 5A, display 416 shows the current input, which was changed to play DVD as shown by user-selectable menu item 508. With reference to FIG. 5B, display 416 shows the new selection that is made by user 104 to play cable preset 1 as shown by user-selectable menu item 510.

In operation, as shown in FIG. 4, controller 408 of client device 308 will execute instructions in remote finder and configuration program 420 to instruct radio 410 to transmit a reconfiguration request, to external server 320 by way of cellular network 116 and internet 118. Controller 402 of external server 320 will execute instructions in remote finder and configuration program 406 to forward the reconfiguration request to gateway device 112. Controller 424 of gateway device 112 will execute instructions in remote finder and configuration program 432 to instruct radio 426 to forward the reconfiguration request to remote 314. Controller 434 of remote 314 will execute instructions in remote finder and configuration program 446 to case radio 436 to instruct input controller 302 to change the input provided to TV 113 from the input as provided by DVD 115 to the input as provided by gateway device 112.

It should be noted that user 102 may also have the ability to change the input in a manner similar to that discussed above. For example, if user 104 were unable to operate a client device on their own, user 102 may perform the procedure. This will be described in greater detail below with reference to FIG. 3B.

FIG. 3B illustrates communication system 300 at a time t₂ in accordance with aspects of the present disclosure.

As shown in the figure, FIG. 3B is similar to FIG. 3A with the exception that user 102 and client device 306 are now out of the client residence.

As shown in the figure, communication system 300 is similar to FIG. 3A with the exception that client device 306 is configured to operate with cellular network 116 via communication channel 322 outside of the residence.

In some embodiments, user 104 may be unable to operate a client device in order to change the input. In this situation, a family member, in this example, user 102, may have access to a client device that can change the input for user 104 even when user 102 is no longer present in the residence.

In the non-limiting examples discussed above, a user interface includes selectable items as described with reference to FIGS. 5A-5B. However, in other embodiments, a client device, such as client device 306, may be enable to receive and act on voice commands by any known manner. As such, rather than actuating GUI 504 as discussed above with reference to FIGS. 5A-B, in some embodiments a user may use a voice command, wherein microphone 418 may receive the voice command. In such embodiments, client device 306 may then transmit the reconfiguration request based on the received voice command.

Returning to FIG. 2, after a reconfiguration request is transmitted (S206), then a reconfiguration request is received (S208). For example, returning to FIG. 4, after a selection has been made on client device 306, controller 408 will execute instructions in remote finder and configuration program 420 to instruct radio 410 to transmit the reconfiguration request to gateway device 112 via cellular network 116, Internet 118, and external server 320. Controller 424 of gateway device 112 will execute instructions in remote finder and configuration program 432 to instruct radio 426 to transmit the reconfiguration request to remote 314.

Returning to FIG. 2, after a reconfiguration request is received (S208), then a reconfiguration instruction is transmitted (S210). For example, with reference to FIG. 4, after radio 436 of remote 314 receives the reconfiguration request, controller 434 executes instructions in remote finder and configuration program to instruct radio 436 to transmit a reconfiguration instruction to input controller 302.

Returning to FIG. 2, after a reconfiguration instruction is transmitted (S210), then the reconfiguration instruction is received (S212). For example, with reference to FIG. 4, radio 436 of remote 314 transmits the reconfiguration instruction to be received by input controller 302, as shown in FIG. 3A. After receiving the reconfiguration construction, input controller 302 may map one of inputs 333, 335, or 337 to output 339 based on the instruction given by client device 308.

Returning to FIG. 2, after a reconfiguration instruction is received (S212), then algorithm 200 stops (S214).

In accordance with algorithm 200 discussed above, a user may easily reconfigure the inputs on input controller 302 by way of their phone, which in the non-limiting example discussed above may be client device 306 or client device 308. Further, because the client devices access remote 314 via cellular network 116, the reconfiguration may be performed even when the client device is not within the residence.

An example system and method for finding a remote control in accordance with aspects of the present disclosure will now be described in greater detail with reference to FIGS. 3A-B, 4, 7, and 8.

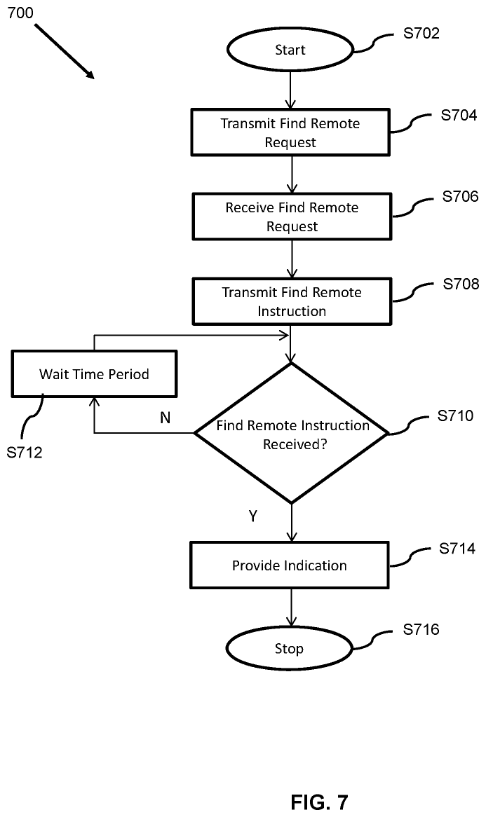

FIG. 7 illustrates an algorithm 700 to be executed by a processor for finding a remote control in accordance with aspects of the present disclosure.

As shown in the figure, algorithm 700 starts (S702), and a find remote request is transmitted (S704). An example will be described in greater detail below.

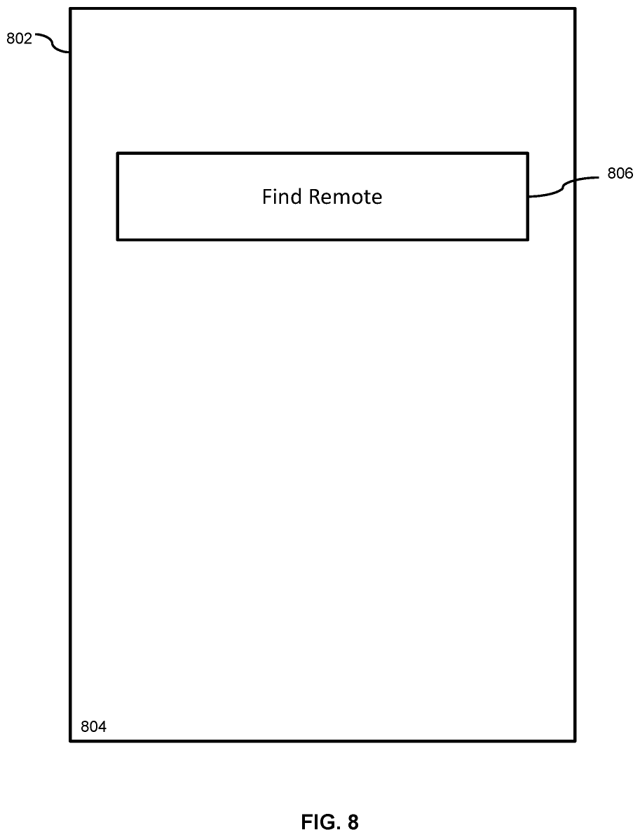

FIG. 8 illustrates a non-limiting example of a display 802 displaying GUI 804 at a time t₆ in accordance with aspects of the present disclosure.

As shown in the figure, display 802 includes a non-limiting example of user-selectable menu item 806, find remote.

For the purpose of discussion, consider the following situation with reference to FIG. 3A. User 104 is an aging person living in the residence and is currently unable to locate remote 314. By using client device 308, they are able to press a button, a non-limiting example of which is shown in FIG. 8 with display 802, find remote, which then transmits a find remote request via radio 410 of client device 306 as shown in FIG. 4.

Returning to FIG. 7, after a find remote request is transmitted (S704), then a find remote request is received (S706). For example, as shown in FIG. 4, radio 410 of client device 306 transmits a find remote request to be received by radio 426 of gateway device 112.

Returning to FIG. 7, after a find remote request is received (S706), then a find remote instruction is transmitted (S708). For example, as shown in FIG. 4, radio 426 of gateway device 112 will receive a find remote request and then transmit a find remote instruction via radio 426.

Returning to FIG. 7, after a find remote instruction is transmitted (S708), then it is determined whether the find remote instruction was received (S710).

Returning to FIG. 7, if it is determined that the find remote instruction was not received (N at S710), then a wait time period starts (S712). For example, with reference to FIG. 3A, imagine that user 104, the aging person, has lost remote 314 within the residence. They then hit the find remote button, as shown in FIG. 8, and a find remote instruction is transmitted. With reference to FIG. 4, it is not efficient for a receiver (not shown) of radio 436 of remote 314 to be constantly on, as this would be a waste battery power. Accordingly, a wait time period for the receiver of radio 436 may be set to maximize effectiveness while minimizing power loss. In short, gateway device 112 may transmit a find remote instruction to remote 314. In a non-limiting example embodiment, this find remote instruction is transmitted via a Bluetooth protocol. There is a chance that remote 314 may be in a sleep mode, wherein radio 436 of remote 314 is not on. Therefore, gateway device 112 may continue to transmit the find remote instruction to remote 314, or transmit the find remote instruction to remote 314 periodically, longer than the wait time period, wherein radio 436 of remote 314 will eventually be on so as to receive the message.

A non-limiting example of a wait time period, or sleep period, could be 30 seconds. Therefore, for purposes of discussion, let radio 436 of remote 314 be in a sleep mode, wherein it is OFF for a period of 30 seconds, so as to conserve power. After the wait time period is over, the receiver of radio 436 is powered. At that point, radio 436 will be ON and able to receive a find remote instruction. The receiver of radio 436 may be powered ON for another predetermined time period, which may be set to maximize effectiveness while minimizing power loss. In a non-limiting example, the receiver may be powered for 45 seconds. Thus, the 30 second OFF period as compared to the 45 second ON period, may ensure that a broadcast of a find remote instruction will be received without powering the receiver all the time.

Returning to FIG. 7, after the wait time period expires (S712), then the remote again determines whether the find remote instruction is received (return to S710). For example, with reference to FIG. 4, once the find remote request is received by remote 314, a light may show from display 442, a sound may come from speaker 444, remote 314 may vibrate, or any combination thereof.

Returning to FIG. 7, if it is determined that the find remote instruction was received (Y at S710), then an indication is provided (S714). For example, with reference to FIG. 4, if the instruction is received, controller 434 may execute instructions in remote finder and configuration program 446 to instruct display 442 to display a light, to instruct speaker 444 to play a sound, to cause a vibration, or any combination thereof.

In some embodiments, controller 434 may execute instructions in remote finder and configuration program 446 to instruct display 442 to display a light, to instruct speaker 444 to play a sound, to cause a vibration, or any combination thereof, for a predetermined period of time, a non-limiting example of which includes 3 seconds.

In some embodiments, the predetermined period of time to display a light, to instruct speaker 444 to play a sound, to cause a vibration, or any combination thereof may be adjusted by user 104. In some of these embodiments, the predetermined period of time to display a light, to instruct speaker 444 to play a sound, to cause a vibration, or any combination thereof may be adjusted by user 104 by way of interface 438 of remote 314.

In some embodiments, the predetermined period of time to display a light, to instruct speaker 444 to play a sound, to cause a vibration, or any combination thereof may be based on the battery life of the battery (not shown) within remote 314. For example, if the battery within remote 314 has a full charge, then the predetermined period of time to display a light, to instruct speaker 444 to play a sound, to cause a vibration, or any combination thereof may be longer than the predetermined period of time to display a light, to instruct speaker 444 to play a sound, to cause a vibration, or any combination thereof if the battery within remote 314 is half-charged.

With remote 314 providing the indication, whether a blinking light, a sound, a vibration, or a combination thereof, user 104 will be able to locate remote 314.

In some embodiments, when user 104 locates remote 314 and uses remote 314, for example by pushing a button on interface 438, remote 314 may transmit a remote located signal to gateway device 112. Upon receiving the remote located signal, gateway device 112 may then transmit the remote located signal to the client device that transmitted the find remote request (discussed above with reference to S704). Upon receiving the remote located signal, the client device that transmitted the find remote request, by provide an indication that remote 314 has been located. As such, in the case where the client device that transmitted that find remote request was client device 308, then user 102 may then be notified that user 104 has located remote 314.

In some embodiments, when user 104 locates remote 314 and moves remote 314, an accelerometer (not shown) or gyroscope (not shown) within remote 314 may indicate that remote 314 has been located. In such cased, remote 314 may then transmit the remote located signal to gateway device 112, which will be transmitted to the client device that transmitted the find remote request as discussed above.

Returning to FIG. 7, after the indication is provided (S714), then algorithm 700 stops (S716).

In accordance with algorithm 700 discussed above, a user may easily find a lost remote way of their phone, which in the non-limiting example discussed above may be client device 306 or client device 308. Further, because the client devices access remote 314 via cellular network 116, the instruction to cause the remote to light up, play a sound, vibrate of perform a combination, may be performed even when the client device is not within the residence.

In accordance with the present disclosure, a system and method provide a user-friendly means of reconfiguring a television and finding a remote control. Aspects of the present disclosure use a client device to make it easy for either an aging user or a family member or caregiver of the aging user to reconfigure a television and/or find a remote control. In order to overcome the issue regarding difficulty selecting inputs, this system and method allow the user to do so from the client device rather than through the remote control. This system additionally uses an input controller that allows the user to select HDMI presets that they are able to choose from their client device. This way, instead of having to remember which input corresponds with which device, the user can assign friendly names such as “watch DVD” or “watch cable” to make the process of changing inputs easier for the aging person.

This system and method also overcome the issue of an aging person having difficulty changing the input to a television in the home by allowing other people, for example, a family member or caregiver, to have access to a client device that allows them to change the input to the television from outside of the home for the aging family member.

This system and method also a person to easily find a remote by having a similar option to choose from on the client device. After hitting the “find remote” command on the client device, the remote may light up, make a sound, vibrate, or any combination thereof, making the remote easier to find for the aging person. This additionally benefits the caregivers or family members of the aging person because they will not have to go to the residence to assist in finding the remote control.

Some advantages of the present disclosure include the aging person having the ability to easily change the input of their device. Not only will this decrease their stress and anxiety regarding the use of technology, it will also allow them to keep some aspect of their independence while aging. Additionally, it allows family members or caregivers to help the aging person without having to step in the home. This may relive some of the stress off of the family members or caregivers while also removing some of the inconvenience associated with going to the residence to help the family member with their devices. Another advantage of the present disclosure is the ability to find a remote that was lost within the residence easily through the use of a client device. Similar to the situations mentioned previously, this can be done by the aging person within the residence or by a caregiver or family member outside of the residence. This again allows the aging person to retain some independence while being able to easily use their devices as well as allowing caregivers or family members to help them as needed.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed is:

1. A client device for use by a user and with a network device, a customer premises device, a remote control device, and an external network, the network device being configured to communicate with the external network and transmit a reconfiguration instruction to the remote control device, the remote control device being configured to transmit a control signal to the customer premises device based on the reconfiguration instruction, the customer premises device being configured to reconfigure based on the control signal, said client device comprising:
a memory; and
a processor configured to execute instructions stored on said memory to cause said client device to:
receive a user input signal associated with a reconfiguration of the customer premises device;
transmit a reconfiguration instruction to the network device via the external network so as to cause the network device to transmit the reconfiguration instruction to the remote control device, to cause the remote control device to transmit the control signal to the customer premises device based on the reconfiguration instruction, and to cause the customer premises device to reconfigure based on the control signal.

2. The client device of claim 1, further comprising a user interface configured to generate the user input signal based on a user input.

3. The client device of claim 2, wherein said user interface includes a microphone configured to generate the user input signal based on a received vocal command by the user.

4. The client device of claim 2, wherein said user interface includes a button configured to generate the user input signal based on a pressing of said button by the user.

5. A method of using a client device for use by a user and with a network device, a customer premises device, a remote control device, and an external network, the network device being configured to communicate with the external network and transmit a reconfiguration instruction to the remote control device, the remote control device being configured to transmit a control signal to the customer premises device based on the reconfiguration instruction, the customer premises device being configured to reconfigure based on the control signal, said method comprising:
receiving, via a processor configured to execute instructions stored on a memory, a user input signal associated with a reconfiguration of the customer premises device; and
transmitting, via the processor, a reconfiguration instruction to the network device via the external network so as to cause the network device to transmit the reconfiguration instruction to the remote control device, to cause the remote control device to transmit the control signal to the customer premises device based on the reconfiguration instruction, and to cause the customer premises device to reconfigure based on the control signal.

6. The method of claim 5, further comprising generating, via a user interface, the user input signal based on a user input.

7. The method of claim 6, wherein said generating the user input signal comprises generating, via a button, the user input signal based on a received vocal command by the user.

8. The method of claim 6, wherein said generating the user input signal comprises generating, via a microphone, the user input signal based on a pressing of the button by the user.

9. A non-transitory, computer-readable media having computer-readable instructions stored thereon, the computer-readable instructions being capable of being read by a client device for use by a user and with a network device, a customer premises device, a remote control device, and an external network, the network device being configured to communicate with the external network and transmit a reconfiguration instruction to the remote control device, the remote control device being configured to transmit a control signal to the customer premises device based on the reconfiguration instruction, the customer premises device being configured to reconfigure based on the control signal, wherein the computer-readable instructions are capable of instructing the client device to perform the method comprising:
receiving, via a processor configured to execute instructions stored on a memory, a user input signal associated with a reconfiguration of the customer premises device; and
transmitting, via the processor, a reconfiguration instruction to the network device via the external network so as to cause the network device to transmit the reconfiguration instruction to the remote control device, to cause the remote control device to transmit the control signal to the customer premises device based on the reconfiguration instruction, and to cause the customer premises device to reconfigure based on the control signal.

10. The non-transitory, computer-readable media of claim 9, wherein the computer-readable instructions are capable of instructing the client device to perform the method further comprising generating, via a user interface, the user input signal based on a user input.

11. The non-transitory, computer-readable media of claim 10, wherein the computer-readable instructions are capable of instructing the client device to perform the method wherein said generating the user input signal comprises generating, via a button, the user input signal based on a received vocal command by the user.

12. The non-transitory, computer-readable media of claim 10, wherein the computer-readable instructions are capable of instructing the client device to perform the method wherein said generating the user input signal comprises generating, via a microphone, the user input signal based on a pressing of the button by the user.

13. A client device for use by a user and with a network device, a customer premises device, a remote control device, and an external network, the network device being configured to communicate with the external network and transmit an instruction to the remote control device, the remote control device being configured to perform a function based on the instruction, said client device comprising:
a memory; and
a processor configured to execute instructions stored on said memory to cause said client device to:
receive a user input signal associated with the function of the remote control device;
transmit the instruction to the network device via the external network so as to cause the network device to transmit the instruction to the remote control device, to cause the remote control device to perform the function.

14. The client device of claim 13, wherein the instruction causes the remote control device to emit a sound.

15. The client device of claim 13, wherein the instruction causes the remote control device to transmit a control signal to the customer premises device to cause the customer premises device to reconfigure based on the control signal.

16. A method of using a client device for use by a user and with a network device, a customer premises device, a remote control device, and an external network, the network device being configured to communicate with the external network and transmit an instruction to the remote control device, the remote control device being configured to perform a function based on the instruction, said method comprising:
receiving, via a processor configured to execute instructions stored on a memory, a user input signal associated with the function of the remote control device; and
transmitting, via the processor, the instruction to the network device via the external network so as to cause the network device to transmit the instruction to the remote control device, to cause the remote control device to perform the function.

17. The method of claim 16, wherein the instruction causes the remote control device to emit a sound.

18. The method of claim 16, wherein the instruction causes the remote control device to transmit a control signal to the customer premises device to cause the customer premises device to reconfigure based on the control signal.

19. A non-transitory, computer-readable media having computer-readable instructions stored thereon, the computer-readable instructions being capable of being read by a client device for use by a user and with a network device, a customer premises device, a remote control device, and an external network, the network device being configured to communicate with the external network and transmit an instruction to the remote control device, the remote control device being configured to perform a function based on the instruction, wherein the computer-readable instructions are capable of instructing the client device to perform the method comprising:
receiving, via a processor configured to execute instructions stored on a memory, a user input signal associated with the function of the remote control device; and
transmitting, via the processor, the instruction to the network device via the external network so as to cause the network device to transmit the instruction to the remote control device, to cause the remote control device to perform the function.

20. The non-transitory, computer-readable media of claim 19, wherein the computer-readable instructions are capable of instructing the client device to perform the method wherein the instruction causes the remote control device to emit a sound.

21. The non-transitory, computer-readable media of claim 19, wherein the computer-readable instructions are capable of instructing the client device to perform the method wherein the instruction causes the remote control device to transmit a control signal to the customer premises device to cause the customer premises device to reconfigure based on the control signal.
